(19) United States
(12) Patent Application Publication
(10) Pub. No.: US 2026/0302757 A1
(43) Pub. Date: Oct. 1, 2026

(54) PLUG-IN-TYPE JOINT BOX

(71) Applicant: TAI HAN ELECTRIC WIRE CO., LTD., Gyeonggi-do (KR)

(72) Inventors: Dong Suk HONG, Chungcheongnam-do (KR); Jae Hyuk SONG, Chungcheongnam-do (KR); Seong Jung KIM, Chungcheongnam-do (KR)

(73) Assignee: TAI HAN ELECTRIC WIRE CO., LTD., Gyeonggi-do (KR)

(21) Appl. No.: 19/477,000

(22) PCT Filed: Apr. 19, 2024
(86) PCT No.: PCT/KR2024/005294

§ 371 Date: Oct. 20, 2025

(30) Foreign Application Priority Data
Apr. 21, 2023 (KR) 10-2023-0052603

(51) Int. Cl. H02G 15/103

(52) U.S. Cl. CPC H02G 15/103

(57) ABSTRACT

A plug-in-type joint box in which an epoxy that is a joining material and a stress cone that a plug-in component are linearly fastened to each other, thereby preventing eccentricity. The plug-in-type joint box may include: a pair of power cables; a pair of stress cones for electric field relief of each of the pair of power cables; an epoxy unit, which encompasses the outside of the pair of stress cones and the pair of power cables and insulates same; a pair of spring compression devices for pressurizing the pair of stress cones on both sides of the epoxy unit; and a pair of protection pipes connected to each of the pair of spring compression devices, The lower end of the pair of protection pipes is formed to have steps, and flanges of the pair of spring compression devices can come into contact with and be coupled to the steps.

### TECHNICAL FIELD

The present invention relates to a plug-in-type joint box, and more particularly, to a plug-in-type joint box in which an epoxy that is a joining material and a stress cone that a plug-in component are linearly fastened to each other, thereby preventing eccentricity.

### BACKGROUND ART

A joint box of an XLPE cable is generally classified into a prefabricated joint (PJ) and a pre-molded joint (PMJ).

The PJ includes a combination of an epoxy insulator and a rubber stress cone, and the PMJ uses silicone rubber (SR) or ethylene propylene rubber (EPR) as a main insulating material.

Also, a joint method may be classified into an IEC type plug-in-type and a compressing leading conductor type (non-IEC type).

The PMJ has a simple structure which allows for easy installation and is internationally the most preferred type. The PMJ is used for connecting cables to each other, and is classified into a normal joint (PMNJ) that connects conductors at both ends and metallic sheaths and an insulated joint (PMIJ) that separates metallic sheaths from each other.

In recent years, a plug-in-type intermediate joint box for restoring a failure of an ultra-high-voltage underground cable, which enable rapid restoration in the event of a failure, is being developed.

In particular, since a failure of the intermediate joint box accounts for a large proportion of failures, and the failure of the intermediate joint box generally causes a damage of adjacent cables, there is a need to develop a joint box having a structure of replacing only the intermediate joint box in a limited manhole space without encroaching on an offset area is required.

In addition to the above-described reasons, there is a need to develop a plug-in-type joining material and joining process, and to develop a joining method in consideration of a safety margin to prevent a joining limitation from occurring during the joining.

### RELATED ART DOCUMENTS

### Patent Documents

(Patent Document 1) Korean Patent Publication No. 10-2004-0084290.

### DISCLOSURE OF THE INVENTION

### Technical Problem

The present invention provides a plug-in-type joint box having a joint structure designed to prevent eccentricity from occurring when joining an epoxy that is a joining material and a stress cone that is a plug-in component.

Technical objects to be solved by the present invention are not limited to the aforementioned technical objects and unmentioned technical objects will be clearly understood by those skilled in the art to which the present invention belongs.

### Technical Solution

An embodiment of the present invention provides a plug-in-type joint box including: a pair of power cables; a pair of stress cones configured to relieve an electric field of each of the pair of power cables; an epoxy unit configured to surround the pair of stress cones and the pair of power cables to provide insulation; a pair of spring compression devices configured to press the pair of stress cones disposed on each of both sides of the epoxy unit with an elastic force; and a pair of protection pipes connected to the pair of spring compression devices, respectively, in which a stepped portion is formed at each of lower ends of the pair of protection pipes, and a flange of each of the pair of spring compression devices is brought into contact with and coupled to the stepped portion.

In an embodiment of the present invention, a plug-in-type joint box includes: a pair of power cables; a pair of stress cones configured to relieve an electric field of each of the pair of power cables; an epoxy unit configured to surround the pair of stress cones and the pair of power cables to provide insulation; a pair of spring compression devices configured to press the pair of stress cones disposed on each of both sides of the epoxy unit with an elastic force; and a pair of protection pipes connected to the pair of spring compression devices, respectively, in which a tap formed on an inner surface of a lower end of each of the pair of protection pipes is engaged with a tap formed on an outer circumference of a flange of each of the pair of spring compression devices.

In an embodiment, each of the pair of protection pipes may have one side connected to a sheath of each of the pair of power cables and the other side fastened to the epoxy unit by using a bolt, and each of the pair of stress cones may be brought into contact with an interface of the epoxy unit without eccentricity by the pair of spring compression devices in conjunction with the fastening of the epoxy unit by using the bolt.

In an embodiment of the present invention, a plug-in-type joint box includes: a power cable; a stress cone configured to relieve an electric field of the power cable; an epoxy bushing configured to surround the stress cone and the power cable to provide insulation; a spring compression device configured to press the stress cone toward the epoxy bushing with an elastic force; and a protection pipe connected to the spring compression device, in which a stepped portion is formed at a lower end of the protection pipe, and a flange of the spring compression device is brought into contact with and coupled to the stepped portion.

In an embodiment of the present invention, a plug-in-type joint box includes: a power cable; a stress cone configured to relieve an electric field of the power cable; an epoxy bushing configured to surround the stress cone and the power cable to provide insulation; a spring compression device configured to press the stress cone toward the epoxy bushing with an elastic force; and a protection pipe connected to the spring compression device, in which a tap formed on an inner surface of a lower end of each of the pair of protection pipes is engaged with a tap formed on an outer circumference of a flange of each of the pair of spring compression devices.

In an embodiment, the protection pipe may have one side connected to a sheath of the power cable and the other side fastened to the epoxy bushing by using a bolt, and the stress cone may be brought into contact with an interface of the epoxy bushing without eccentricity by the spring compression device in conjunction with the fastening of the epoxy bushing by using the bolt.

### Advantageous Effects

According to the present invention, the plug-in-type joint box having the joining structure designed to prevent eccentricity from occurring when joining the epoxy that is the joining material and the stress cone that is the plug-in component.

Also, since the eccentricity does not occur when joining the stress cone, the electrical limitations such as the insulation breakdown caused by long-term use may be solved.

However, the effects of the present invention are not limited to the aforementioned effects, and various modifications and extensions may be made without departing from the spirit and scope of the present invention.

### BRIEF DESCRIPTION OF THE DRAWINGS

FIG. 1 is a view illustrating an intermediate joint box to which a first embodiment of a linear fastening method between an epoxy unit and a stress cone of a plug-in-type joint box according to an embodiment of the present invention is applied.

FIG. 2 is a view illustrating a terminal joint box to which the first embodiment of the linear fastening method between the epoxy unit and the stress cone of the plug-in-type joint box according to an embodiment of the present invention is applied.

FIG. 3 is a view illustrating an intermediate joint box to which a second embodiment of the linear fastening method between the epoxy unit and the stress cone of the plug-in-type joint box according to an embodiment of the present invention is applied.

FIG. 4 is a view illustrating a terminal joint box to which the second embodiment of the linear fastening method between the epoxy unit and the stress cone of the plug-in-type joint box according to an embodiment of the present invention is applied.

### MODE FOR CARRYING OUT THE INVENTION

The present invention will now be described more fully with reference to the accompanying drawings, in which exemplary embodiments of the invention are shown. These embodiments are provided so that this disclosure will be thorough and complete, and will fully convey the concept of the invention to those skilled in the art. The invention may, however, be embodied in many different forms and should not be construed as being limited to the embodiments set forth herein. Therefore, it will be understood that the embodiments disclosed in this specification includes some variations without limitations to the shapes as illustrated in the figures. Also, the position or the arrangement of each component in the embodiment may be varied without departing form the spirit or scope of the invention. The preferred embodiments should be considered in descriptive sense only and not for purposes of limitation. Therefore, the scope of the invention is defined not by the detailed description of the invention but by the appended claims, and all differences within the scope will be construed as being included in the present invention. In the drawings, like reference numerals refer to like elements throughout.

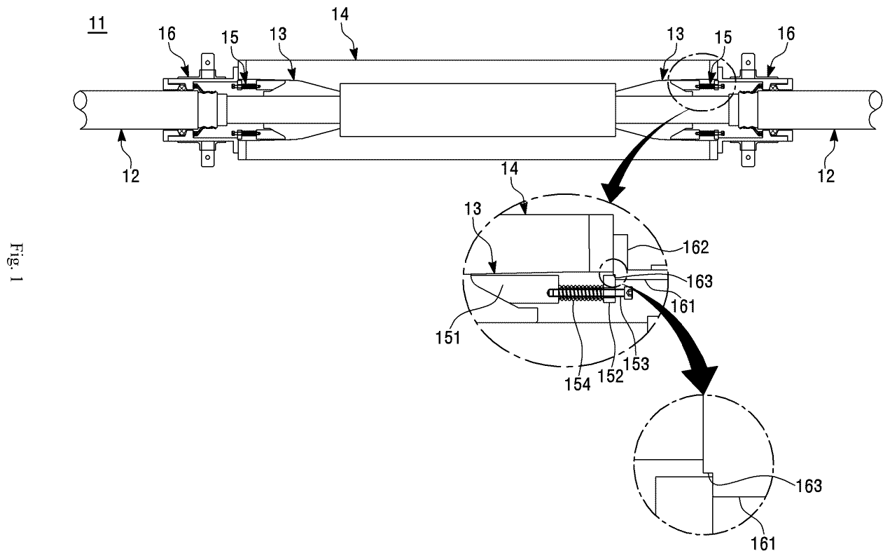

FIG. 1 is a view illustrating an intermediate joint box to which a first embodiment of a linear fastening method between an epoxy unit and a stress cone of a plug-in-type joint box according to an embodiment of the present invention is applied.

As illustrated in FIG. 1, a plug-in-type intermediate joint box 11 according to an embodiment of the present invention may include: a power cable 12 disposed at each of both sides thereof to supply electricity; a stress cone 13 that relieves an electric field of a shielding unit of the power cable 12; an epoxy unit 14 that surrounds the stress cone 13 and the power cables 12 to provide insulation; a spring compression device 15 that elastically presses the epoxy unit 14 and the stress cone 13; and a protection pipe 16 that protects the inside of the power cable 12, the epoxy unit 14, and the spring compression device 15 from the outside.

The intermediate joint box 11 for power cables is manufactured by removing an outer semi-conductive layer of the power cable 12 to form a cable conductor (not shown), and then mounting the stress cone 13 that relieves an electric field of the shielding unit of the power cable 12 and the epoxy unit 14 that is a main reinforcing insulator.

A spring compression device 15, which applies a predetermined force to push the stress cone 13, may be installed on one side of the stress cone 13, and a stopper (not shown) may be installed on the other side of the stress cone 13 to prevent the stress cone 13 from being pushed inward.

An embedded electrode (not shown) made of aluminum may be installed between the cable conductor (not shown) and the epoxy unit 14 for the purpose of relieving an electric field generated between the cable conductors (not shown).

The intermediate joint box 11 for power cables having the above-described configuration is surrounded and protected by the protection pipe 16 to protect components against external impact during burial or installation.

The protection pipe 16 may have one side connected to a sheath of the power cable 12 and the other side fastened to the epoxy unit 14 by using a bolt.

The intermediate joint box 11 for power cables may necessarily have interface pressure between respective insulation components, which is equal to or greater than a design value, to prevent insulation breakdown from occurring even when extra-high voltage power is applied because various insulation components are coupled and fastened to each other. In addition, an air layer existing at a connected portion of the cable conductors (not shown) may generate corona discharge, thereby eventually causing insulation breakdown at the connected portion of the power cables.

In particular, since the stress cone 13 and the epoxy unit 14, which are insulators having different dielectric constants, are surface-to-surface coupled to each other, it is important that the coupling is performed so as to prevent interface pressure between heterogeneous insulators and to prevent eccentricity occurring during the coupling between heterogeneous insulators.

In order to solve the above-described limitation, the present invention prevents eccentricity for uniform interface pressure between heterogeneous insulators through the fastening structure as in the enlarged view of FIG. 1.

Referring to the enlarged view, the spring compression device 15 may include: a pressure contact part 151 that is in pressure-contact with and pushes an inclined surface of the stress cone 13; a flange 152 having a circular plate shape; a plurality of fastening bolts 153 that connect the pressure contact part 151 and the flange 152 to adjust a spaced distance therebetween; and a plurality of compression rings 154 fitted over the fastening bolts 153 to apply elastic force.

In addition, the protection pipe 16 may include a cylindrical pipe 161 having a cylindrical shape and a pipe flange 162 disposed at a front end of the cylindrical pipe 161. The cylindrical pipe 161 and the pipe flange 162 may be integrated with each other, or be manufactured separately and then coupled to each other by welding.

A stepped portion 163 that is directed inward may be formed in an inner diameter of the pipe flange 162, and the flange 152 of the spring compression device 15 may be seated on the stepped portion 163, so that the spring compression device 15 and the protection pipe 16 are brought into contact with each other and fastened to be fixed.

The protection pipe 16 may have an inner front end, with which the spring compression device 15 is in pressure contact, and at an outer front end, which is fastened to the epoxy unit 14 by using a bolt.

The spring compression device 15 is assembled in a state in which a compressive force (elastic force) is adjusted in advance by the fastening bolt 153 and the compression rings 154 before the protection pipe 16 is fastened, and the interface pressure between the stress cone 13 and the epoxy unit 14 is applied while pushing the spring compression device 15 toward the stress cone 13 by the stepped portion 163 as the protection pipe 16 is fastened to the epoxy unit 14.

Here, as the spring compression device 15 is in pressure contact with the stepped portion 163 of the protection pipe 16 to apply a uniform force in a circumferential direction, the stress cone 13 may be brought into contact with an interface of the epoxy unit 14 with a predetermined force without eccentricity.

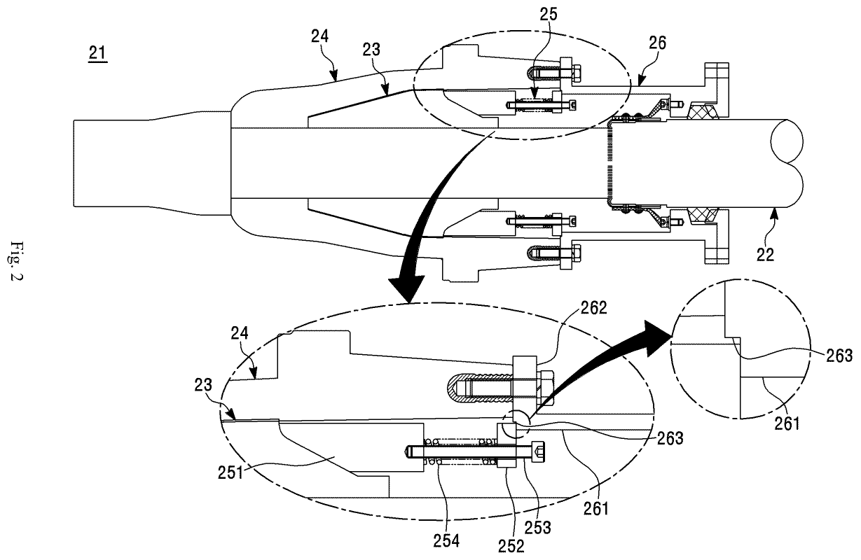

FIG. 2 is a view illustrating a terminal joint box to which the first embodiment of the linear fastening method between the epoxy unit and the stress cone of the plug-in-type joint box according to an embodiment of the present invention is applied.

As illustrated in FIG. 2, a plug-in-type terminal joint box 21 according to an embodiment of the present invention may include: a power cable 22 that supplies electricity; a stress cone 23 for relieving an electric field of a shielding part of the power cable 22; an epoxy bushing 24 that surrounds the stress cone 23 and the power cable 22 to provide insulation; a spring compression device 25 that elastically presses the epoxy bushing 24 and the stress cone 23; and a protection pipe 26 that protects the inside of the power cable 22 from the outside.

The terminal joint 21 for power cables is manufactured by removing an outer semi-conductive layer of the power cable 22 to form a cable conductor (not shown), sealing the cable conductor at a front end with a corona shield, and then mounting the stress cone 23 that relieves an electric field of the shielding unit of the power cable 22 and the epoxy unit 24 that is a main reinforcing insulator.

A spring compression device 25, which applies a predetermined force to push the stress cone 23, may be installed on one side of the stress cone 23, and a stopper (not shown) may be installed on the other side of the stress cone 23 to prevent the stress cone 23 from being pushed inward.

An embedded electrode (not shown) made of aluminum may be mounted to the cable conductor, and an epoxy bushing 24 may be mounted around the embedded electrode for the purpose of relieving an electric field generated at a front end of the cable conductor.

The terminal joint box 21 for power cables having the above-described configuration is surrounded by a protection pipe 26 to protect components such as the cable from external impact during burial or installation.

The protection pipe 26 may have one side connected to a sheath of the power cable 22 and the other side fastened to the epoxy bushing 24 by using a bolt.

Since the stress cone 23 and the epoxy unit 24, which are insulators having different dielectric constants, are surface-to-surface coupled to each other, it is important that the coupling is performed to prevent interface pressure between heterogeneous insulators and to prevent eccentricity occurring during the coupling between heterogeneous insulators.

The present invention prevents eccentricity for uniform interface pressure between heterogeneous insulators through the fastening structure as in the enlarged view of FIG. 2.

Referring to the enlarged view of FIG. 2, the spring compression device 25 may include: a pressure contact part 251 that is in pressure-contact with and pushes an inclined surface of the stress cone 23; a flange 252 having a circular plate shape; a plurality of fastening bolts 253 that connect the pressure contact part 251 and the flange 252 to adjust a spaced distance therebetween; and a plurality of compression rings 254 fitted over the fastening bolts 253 to apply elastic force.

In addition, the protection pipe 26 may include a cylindrical pipe 261 having a cylindrical shape and a pipe flange 262 disposed at a front end of the cylindrical pipe 261. The cylindrical pipe 261 and the pipe flange 262 may be integrated with each other, or be manufactured separately and then coupled to each other by welding.

A stepped portion 263 that is directed inward may be formed in an inner diameter of the pipe flange 262, and the flange 252 of the spring compression device 25 may be seated on the stepped portion 263, so that the spring compression device 25 and the protection pipe 26 are brought into contact with each other and fastened to be fixed.

The protection pipe 26 may have an inner front end, with which the spring compression device 25 is in pressure contact, and at an outer front end, which is fastened to the epoxy unit 24 by using a bolt.

The spring compression device 25 is assembled in a state in which a compressive force (elastic force) is adjusted in advance by the fastening bolt 253 and the compression rings 254 before the protection pipe 26 is fastened, and the interface pressure between the stress cone 23 and the epoxy bushing 24 is applied while pushing the spring compression device 25 that is brought into pressure contact by the stepped portion 263 as the protection pipe 26 is fastened to the epoxy bushing 24.

Here, as the spring compression device 25 is in pressure contact with the stepped portion 263 of the protection pipe 26 to apply a uniform force in a circumferential direction, the stress cone 23 may be brought into contact with an interface of the epoxy bushing 24 with a predetermined force without eccentricity.

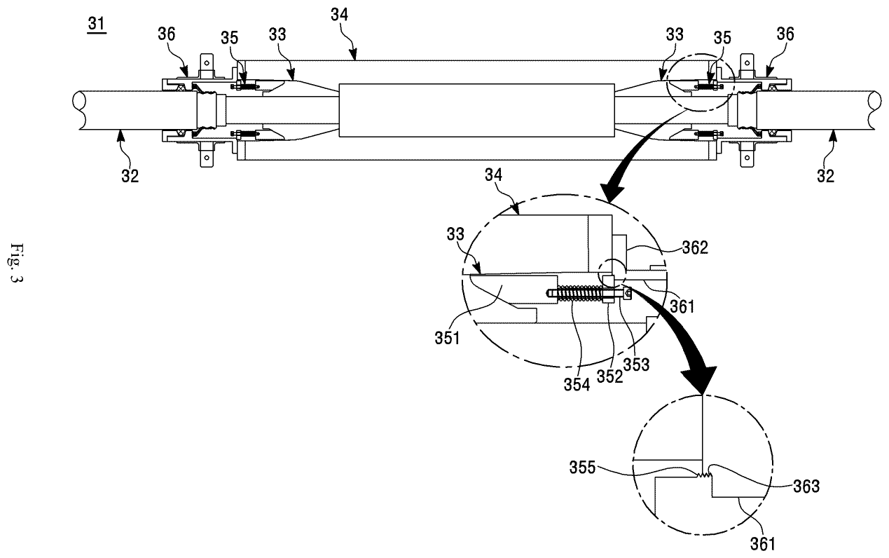

FIG. 3 is a view illustrating an intermediate joint box to which a second embodiment of the linear fastening method between the epoxy unit and the stress cone of the plug-in-type joint box according to an embodiment of the present invention is applied.

The present invention illustrated in FIG. 3 is the same as the invention illustrated in FIG. 1 except for the fastening structure between the protection pipe and the spring compression device for preventing eccentricity of the stress cone.

A plug-in-type intermediate joint box 31 according to an embodiment of the present invention may include: a power cable 32 configured to supply electricity; a stress cone 33 that relieves an electric field of a shielding unit of the power cable 32; an epoxy unit 34 that surrounds the stress cone 33 and the power cables 32 to provide insulation; a spring compression device 35 that elastically presses the epoxy unit 34 and the stress cone 33; and a protection pipe 36 that protects the inside of the power cable 32, the epoxy unit 34, and the spring compression device 35 from the outside.

Referring to the enlarged view of FIG. 3, the spring compression device 35 may include: a pressure contact part 351 that is in pressure-contact with and pushes an inclined surface of the stress cone 33; a flange 352 having a circular plate shape; a plurality of fastening bolts 353 that connect the pressure contact part 351 and the flange 352 to adjust a spaced distance therebetween; and a plurality of compression rings 354 fitted over the fastening bolts 353 to apply elastic force.

In addition, the protection pipe 36 may include a cylindrical pipe 361 having a cylindrical shape and a pipe flange 362 disposed at a front end of the cylindrical pipe 361. The cylindrical pipe 361 and the pipe flange 362 may be integrated with each other, or be manufactured separately and then coupled to each other by welding.

A first tap 363 may be formed on an inner diameter of the pipe flange 362, and a second tab 355 that is engaged with the first tap 363 in a corresponding manner may be formed on an outer circumference of the flange 352.

As the first tab 363 and the second tab 355 are screw-engaged with each other, the spring compression device 35 and the protection pipe 36 may be fastened to be brought into contact with and fixed to each other.

The protection pipe 36 may have an inner front end, with which the spring compression device 35 is in pressure contact, and at an outer front end, which is fastened to the epoxy unit 34 by using a bolt.

The spring compression device 35 is assembled in a state in which a compressive force (elastic force) is adjusted in advance by the fastening bolt 353 and the compression rings 354 before the protection pipe 36 is fastened, and the interface pressure between the stress cone 33 and the epoxy unit 34 is applied while pushing the spring compression device 35 toward the stress cone 33 by the stepped portion 363 as the protection pipe 36 is fastened to the epoxy unit 34.

Here, as the spring compression device 35 is in pressure contact with the tap coupling of the protection pipe 36 to apply a uniform force in a circumferential direction, the stress cone 33 may be brought into contact with an interface of the epoxy unit 34 with a predetermined force without eccentricity.

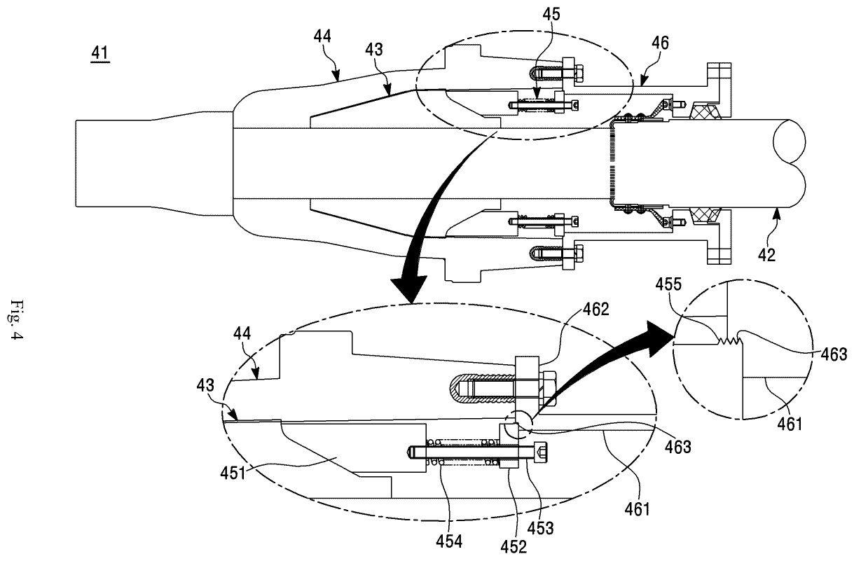

FIG. 4 is a view illustrating a terminal joint box to which the second embodiment of the linear fastening method between the epoxy unit and the stress cone of the plug-in-type joint box according to an embodiment of the present invention is applied.

The present invention illustrated in FIG. 4 is the same as the invention illustrated in FIG. 1 except for the fastening structure between the protection pipe and the spring compression device for preventing eccentricity of the stress cone.

A plug-in-type intermediate joint box 41 according to an embodiment of the present invention may include: a power cable 42 that supplies electricity; a stress cone 43 that relieves an electric field of a shielding unit of the power cable 42; an epoxy bushing 44 that surrounds the stress cone 43 and the power cables 42 to provide insulation; a spring compression device 45 that elastically presses the epoxy unit 44 and the stress cone 43; and a protection pipe 46 that protects the inside of the power cable 42 from the outside.

Referring to the enlarged view of FIG. 4, the spring compression device 45 may include: a pressure contact part 451 that is in pressure-contact with and pushes an inclined surface of the stress cone 43; a flange 452 having a circular plate shape; a plurality of fastening bolts 453 that connect the pressure contact part 451 and the flange 452 to adjust a spaced distance therebetween; and a plurality of compression rings 454 fitted over the fastening bolts 453 to apply elastic force.

In addition, the protection pipe 46 may include a cylindrical pipe 461 having a cylindrical shape and a pipe flange 462 disposed at a front end of the cylindrical pipe 461. The cylindrical pipe 461 and the pipe flange 462 may be integrated with each other, or be manufactured separately and then coupled to each other by welding.

A third tap 463 may be formed on an inner diameter of the pipe flange 462, and a fourth tab 455 that is engaged with the third tap 463 in a corresponding manner may be formed on an outer circumference of the flange 452.

As the third tab 463 and the fourth tab 455 are screw-engaged with each other, the spring compression device 45 and the protection pipe 46 may be fastened to be brought into contact with and fixed to each other.

The protection pipe 46 may have an inner front end, with which the spring compression device 45 is in pressure contact, and at an outer front end, which is fastened to the epoxy bushing 44 by using a bolt.

The spring compression device 45 is assembled in a state in which a compressive force (elastic force) is adjusted in advance by the fastening bolt 453 and the compression rings 454 before the protection pipe 46 is fastened, and the interface pressure between the stress cone 43 and the epoxy bushing 44 is applied while pushing the spring compression device 45 that is brought into pressure contact by the tap engagement toward the stress cone 43 as the protection pipe 46 is fastened to the epoxy bushing 44.

Here, as the spring compression device 45 is in pressure contact with the tap engagement of the protection pipe 46 to apply a uniform force in a circumferential direction, the stress cone 43 may be brought into contact with an interface of the epoxy bushing 44 with a predetermined force without eccentricity.

Features, structures, and effects described in the above embodiments are incorporated into one embodiment of the present disclosure, but are not limited to only one embodiment. Moreover, features, structures, and effects exemplified in one embodiment may easily be combined and modified for another embodiment by those skilled in the art. Therefore, these combinations and modifications should be construed as falling within the scope of the present disclosure. Therefore, these combinations and modifications should be construed as falling within the scope of the present disclosure.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### DESCRIPTION OF REFERENCE NUMERALS

11, 21: Plug-in-type intermediate joint box
12, 22, 32, 42: Power cable
13, 23, 33, 43: Stress cone
14, 34: Epoxy unit
24, 44: Epoxy bushing
15, 25, 35, 45: Spring compression device
16, 26, 36, 46: Protection pipe

1. A plug-in-type joint box comprising:
a pair of power cables;
a pair of stress cones configured to relieve an electric field of each of the pair of power cables;
an epoxy unit configured to surround the pair of stress cones and the pair of power cables to provide insulation;
a pair of spring compression devices configured to press the pair of stress cones disposed on each of both sides of the epoxy unit with an elastic force; and
a pair of protection pipes connected to the pair of spring compression devices, respectively,
wherein a stepped portion is formed at each of lower ends of the pair of protection pipes, and a flange of each of the pair of spring compression devices is brought into contact with and coupled to the stepped portion.

2. A plug-in-type joint box comprising:
a pair of power cables;
a pair of stress cones configured to relieve an electric field of each of the pair of power cables;
an epoxy unit configured to surround the pair of stress cones and the pair of power cables to provide insulation;
a pair of spring compression devices configured to press the pair of stress cones disposed on each of both sides of the epoxy unit with an elastic force; and
a pair of protection pipes connected to the pair of spring compression devices, respectively,
wherein a tap formed on an inner surface of a lower end of each of the pair of protection pipes is engaged with a tap formed on an outer circumference of a flange of each of the pair of spring compression devices.

3. The plug-in-type joint box of claim 1, wherein each of the pair of protection pipes has one side connected to a sheath of each of the pair of power cables and the other side fastened to the epoxy unit by using a bolt, and
each of the pair of stress cones is brought into contact with an interface of the epoxy unit without eccentricity by the pair of spring compression devices in conjunction with the fastening of the epoxy unit by using the bolt.

4. A plug-in-type joint box comprising:
a power cable;
a stress cone configured to relieve an electric field of the power cable;
an epoxy bushing configured to surround the stress cone and the power cable to provide insulation;
a spring compression device configured to press the stress cone toward the epoxy bushing with an elastic force; and
a protection pipe connected to the spring compression device,
wherein a stepped portion is formed at a lower end of the protection pipe, and a flange of the spring compression device is brought into contact with and coupled to the stepped portion.

5. A plug-in-type joint box comprising:
a power cable;
a stress cone configured to relieve an electric field of the power cable;
an epoxy bushing configured to surround the stress cone and the power cable to provide insulation;
a spring compression device configured to press the stress cone toward the epoxy bushing with an elastic force; and
a protection pipe connected to the spring compression device,
wherein a tap formed on an inner surface of a lower end of each of the pair of protection pipes is engaged with a tap formed on an outer circumference of a flange of each of the pair of spring compression devices.

6. The plug-in-type joint box of claim 4, wherein the protection pipe has one side connected to a sheath of the power cable and the other side fastened to the epoxy bushing by using a bolt, and
the stress cone is brought into contact with an interface of the epoxy bushing without eccentricity by the spring compression device in conjunction with the fastening of the epoxy bushing by using the bolt.

7. The plug-in-type joint box of claim 2, wherein each of the pair of protection pipes has one side connected to a sheath of each of the pair of power cables and the other side fastened to the epoxy unit by using a bolt, and
each of the pair of stress cones is brought into contact with an interface of the epoxy unit without eccentricity by the pair of spring compression devices in conjunction with the fastening of the epoxy unit by using the bolt.

8. The plug-in-type joint box of claim 5, wherein the protection pipe has one side connected to a sheath of the power cable and the other side fastened to the epoxy bushing by using a bolt, and
the stress cone is brought into contact with an interface of the epoxy bushing without eccentricity by the spring compression device in conjunction with the fastening of the epoxy bushing by using the bolt.
